(19) United States
(12) Patent Application Publication
(10) Pub. No.: US 2007/0170612 A1
(43) Pub. Date: Jul. 26, 2007

(54) PROCESS FOR INTRODUCING AT LEAST ONE CHEMICAL COMPOUND INTO AN EXTRUDER, INTRODUCTION DEVICE, EXTRUDER EQUIPPED WITH SUCH A DEVICE AND PROCESSES USING SUCH AN EXTRUDER

(75) Inventors: Dino Manfredi, Houthalen-Helchteren (BE); Fernand Gauthy, Wemmel (BE)

Correspondence Address: OBLON, SPIVAK, MCCLELLAND, MAIER & NEUSTADT, P.C., 1940 DUKE STREET, ALEXANDRIA, VA, 22314, US

(73) Assignee: SOLVAY (SOCIETE ANONYME), Bruxelles (BE)

(21) Appl. No.: 11/687,838

(22) Filed: Mar. 19, 2007

Related U.S. Application Data
(63) Continuation of application No. 10/030,144, filed on Apr. 30, 2002.

(30) Foreign Application Priority Data
Jul. 27, 1999 (BE) 09900511

(51) Int. Cl. B27N 3/08

(52) U.S. Cl. 264/83

(57) ABSTRACT

A method for modifying or synthesizing a polymeric material where a chemical compound and supercritical carbon dioxide are introduced into an extruder, and extruding the raw material or polymeric material under conditions permitting reaction with the chemical compound.

The invention relates to a process for introducing at least one chemical compound into an extruder, to a device for introducing at least one chemical compound into an extruder, to an extruder equipped with at least one introduction device as well as to a process for extruding, a process for modifying and a process for synthesizing a polymeric material by means of such an extruder.

The technique known as reactive extrusion consists in using well-known extrusion devices (more simply called extruders) for the extrusion of materials to be extruded in the melt.

This technique of reactive extrusion is used not only for extruding polymeric materials, in order to synthesize polymeric materials starting from materials to be polymerized, but also for the subsequent chemical conversion of the polymeric materials obtained. These various processes usually require the addition of at least one chemical compound.

A major difficulty encountered when using this technique arises when chemical compounds must be added in the fluidized state. This is because it then becomes very difficult to ensure that they are incorporated into the material to be extruded without problems arising due to the heterogeneous distribution of the chemical compounds in the material to be extruded.

This is all the more so when the amounts of chemical compounds to be introduced are relatively small, for example a few tenths to a few hundreds of microlitres per minute.

One of the solutions already proposed in the past is to dilute the chemical compounds in organic solvents. However, major drawbacks are encountered when using these solvents. Among them, mention may especially be made of not only the limited solubility of certain chemical compounds in organic solvents, the toxicity of some of these organic solvents, the time needed to prepare the solutions of chemical compounds in solvents and the removal of the solvent afterwards, but also the occurrence of undesirable side reactions due to the presence of solvent.

Another solution is to impregnate the material to be extruded with the chemical compound or compounds before their introduction into the extruder. However, this solution requires an additional handling step, which is expensive and laborious. In addition, it does not always allow a high degree of flexibility to be achieved as regards introducing chemical compounds.

To remedy the drawbacks of the solutions proposed in the past, the subject of the present invention is firstly a process allowing at least one chemical compound to be incorporated continuously.

For this purpose, the present invention firstly relates to a process for introducing at least one chemical compound into an extruder, in which the following steps are carried out:
a material to be extruded is introduced into the extruder;
at least one mixture of at least one chemical compound and of carbon dioxide is introduced into the extruder; and
the material is extruded together with the mixture or mixtures.

During the latter step of the process according to the invention, the carbon dioxide may or may not be mixed with the material to be extruded as is the chemical compound. Preferably, the carbon dioxide, being in the gaseous state in the extruder, is not mixed with the material to be extruded, and neither is the chemical compound.

The term “extruder” is understood to mean any continuous device comprising at least one feed zone and, at its exit, a discharge zone preceded by a compression zone, the latter forcing the melt to pass through the discharge zone.

The extruder may comprise, in particular, the following parts:
i. at least one feed zone (feed hopper or injector);
ii. one or more screw elements used for propagating the material to be extruded;
iii. optionally, one or more kneading elements;
iv. one or more heating and/or reaction zones in which the material to be extruded is in the fluiding state; and
v. at the exit, a compression zone followed by a discharge zone, the compression zone having the function of compressing the material to be extruded so as to force it through the discharge zone of the extruder.

Parts (i) to (v) are not necessarily placed in this order.

Optionally, the discharge zone may furthermore be followed by a granulator or by a device giving the extruded material a profiled shape, such as a film.

Extruders that may be suitable are, in particular, extruders of the single-screw type, extruders of the co-kneader type such as, for example, the extruders sold by Buss, extruders of the interpenetrating or non-interpenetrating corotating twin-screw type as sold by Werner & Pfleiderer, extruders of the interpenetrating or noninterpenetrating, counterrotating twin-screw type and extruders of the multiple-screw type. Advantageously, an extruder based on the work of two screws, whether they are corotating or counterrotating, will be used.

Preferably, in the process for introducing at least one chemical compound into an extruder according to the invention, the mixture or mixtures of at least one chemical compound and of carbon dioxide are introduced into a zone of the extruder where the material to be extruded is in the fluidized state.

Any device allowing the mixture of at least one chemical compound and of carbon dioxide to be introduced can be used. One particularly preferred device is the device according to the invention.

The process according to the invention is also characterized in that the mixture or mixtures of at least one chemical compound and of carbon dioxide are introduced by means of at least one introduction device comprising an injector placed perpendicular to the barrel of the extruder.

Particularly preferably, the mixture or mixtures of at least one chemical compound and of carbon dioxide are introduced by means of an introduction device comprising an injector placed perpendicular to a zone in which the material to be extruded is in the fluidized state.

Depending on the temperature and pressure conditions, the carbon dioxide may be in the liquid, gaseous or supercritical state. If the pressure is above 74 bar and the temperature above 31.4° C., as is usually the case in the extruder used for introducing it into the extruder, the carbon dioxide is in the supercritical state.

The term “chemical compound” is understood to mean, for the purposes of the present invention, any chemical compound chosen from chemical compounds capable of causing a chemical change in a polymeric material, those capable of causing polymerization of a material to be polymerized into a polymeric material (these chemical compounds also being called chemical initiators), but also those which do not cause a chemical change in the polymeric material but which provide them with certain advantages after they have been extruded in the presence thereof. Among this latter category, mention may be made, for example, of conventional additives for polymeric materials (stabilizers, lubricants, etc.).

The process according to the invention therefore applies not only to the introduction into the extruder of a single chemical compound as a mixture with carbon dioxide, but also to the introduction of several chemical compounds as a mixture with carbon dioxide and to the introduction of one or more mixtures of one or more chemical compounds as a mixture with carbon dioxide.

The chemical compound or compounds introduced by means of the process according to the invention are preferably in the fluidized state.

The expression “chemical in the fluidized state” is understood to mean, for the purposes of the present invention, any chemical compound which is in a fluid state at the temperature and pressure at which it is introduced into the extruder. Among these mention may be made of chemical compounds which are liquid at room temperature, but also chemical compounds which, although being solid at room temperature, are liquid, possibly viscous liquids, at the temperature and pressure of introduction by the device into the extruder.

The expression “material to be extruded” is understood to mean, for the purposes of the present invention, any material capable of being extruded. Mention may be made, for example, of polymeric materials, but also materials to be polymerized. The term “a material” is understood to mean, for the purposes of the present invention, both a single material and a mixture of several materials. The process according to the present invention therefore applies not only to one or more polymeric mixtures or one or more materials to be polymerized but also to mixtures of at least one polymeric material and of at least one material to be polymerized.

The expression “material to be extruded in the fluidized state” is understood to mean, for the purposes of the present invention, that the material to be extruded, defined above, is in a fluid state, in other words it is a liquid, possibly a viscous liquid, at the temperature and pressure of the extruder. As a general rule, in the process according to the invention, the materials to be polymerized are in the liquid state and the polymeric materials are in the viscous liquid state at the temperature and pressure of the extruder.

The invention also relates to a device for introducing at least one chemical compound into an extruder.

For this purpose, the invention relates to a device for introducing at least one chemical compound into an extruder comprising at least two pumps, a mixing chamber and an injector.

According to an advantageous embodiment, the introduction device comprises:
a pump (1) for feeding at least one chemical compound into the mixing chamber;
a pump (1′) for feeding carbon dioxide into the mixing chamber;
a mixing chamber; and
an injector.

The device according to the invention is usually well suited for introducing any chemical compound in the fluidized state.

Thus, the device according to the invention is in general well suited for introducing chemical compounds which are liquid at room temperature. In general, the device according to the invention can also be used to introduce chemical compounds which are solid at room temperature. In the latter case, the device has to be modified so that it can be raised to a temperature such that these chemical compounds are again in a fluidized state, in other words they are liquids, possibly viscous liquids.

The device according to the invention is usually well suited for introducing amounts of chemical compound less than or equal to 2 ml/min., preferably less than or equal to 1 ml/min. and particularly preferably less than or equal to 600 μl/min.

The device according to the invention is usually well suited for introducing amounts of chemical compound greater than or equal to 1 μl/min., preferably greater than or equal to 3 μl/min. and particularly preferably greater than or equal to 5 μl/min.

Preferably, the carbon dioxide is cooled before it enters the pump (1′). To do this, a cryothermostat is generally place between the carbon dioxide container and the pump (1′).

With regard to the pumps used for feeding the chemical compound or compounds and the carbon dioxide into the mixing chamber, any pump allowing small amounts of compounds circulated can be used.

Any mixing chamber ensuring optimum mixing of the chemical compound or compounds introduced in small amount and of the carbon dioxide may be used in the device according to the invention, whether or not it is equipped with a stirring system.

Preferably, the mixing chamber used in the device according to the invention is equipped with a stirring system.

Usually, the amount of chemical compound or compounds in the mixture of the latter with carbon dioxide in the mixing chamber is less than or equal to 50%, preferably less than or equal to 30% and more particularly less than or equal to 15% by volume.

Any injector able to work at high pressure may be used in the device according to the invention.

Usually, a pressure sensor is used to measure the pressure in the injector.

The pressure in the injector is usually at least 74 bar, preferably at least 85 bar, particularly preferably at least 90 bar and most particularly preferably at least 100 bar.

Usually, when the temperature in the injector is high enough, the carbon dioxide is then in the supercritical state in the injector.

Any kind of extruder as defined above may be equipped with the device according to the invention.

According to another aspect of the present invention, what is also proposed is an extruder which comprises a feed zone, a compression zone and a discharge zone and is equipped with at least one introduction device according to the invention.

The expression “at least one introduction device” is understood to mean one or more introduction devices which allow one or more chemical compounds to be introduced simultaneously or separately into the stream of material to be extruded.

The extruder may also contain, preferably after the zone (iv), a venting zone so as to remove the excessive amounts of chemical compounds that have not reacted, carbon dioxide and possibly by-products generated during the extrusion. The carbon dioxide may also be removed via the feed zone of the extruder.

The injector of each introduction device is preferably placed so as to be perpendicular to the barrel of the extruder and emerges tangentially with respect to the extrusion screw flights.

Advantageously, the injector of each introduction device is placed so as to be perpendicular to a zone where the material to be extruded is in the fluidized state. In this way, the chemical compound or compounds introduced are sprayed onto the material in the fluidized state or injected into the fluidized material.

Such an extruder is particularly beneficial for the extrusion, chemical modification and synthesis of polymeric materials.

The term “polymeric material” is understood to mean, for the purposes of the present invention, both a single polymeric material and mixtures of at least two polymeric materials.

Among polymeric materials, mention may be made, for example, of vinyl polymers but also thermoplastic aliphatic polyesters. Among vinyl polymers, mention may be made of homopolymers and copolymers of olefins and halogenated vinyl homopolymers and copolymers. Among the latter, mention may be made of vinylidene fluoride homopolymers and copolymers. Among thermoplastic aliphatic polyesters, mention may be made, for example, of ε-caprolactone polymers.

According to another aspect of the present invention, what is also proposed is a process for extruding a polymeric material by means of the extruder described above, in which:
a polymeric material is introduced into the extruder;
in each introduction device present:
   at least one chemical compound is introduced, via a pump, into the mixing chamber,
   carbon dioxide, precooled, is introduced via a pump into the mixing chamber and
   the chemical compound or compounds and the carbon dioxide are mixed in the mixing chamber;
   the mixture or mixtures thus obtained are introduced into the extruder; and
   the polymeric material is extruded together with the mixture or mixtures.

According to another aspect of the present invention, what is also proposed is a process for modifying a polymeric material by means of the extruder described above, in which:
a polymeric material is introduced into the extruder;
in each introduction device present:
   at least one chemical compound is introduced via a pump into the mixing chamber,
   the carbon dioxide, precooled, is introduced via a pump into the mixing chamber and
   the chemical compound or compounds and the carbon dioxide are mixed in the mixing chamber;
the mixture or mixtures thus obtained are introduced into the extruder; and
the polymeric material is extruded together with the mixture or mixtures under conditions allowing a reaction between at least one of the chemical compounds and the polymeric material.

Such a modification process is particularly beneficial for the modification of polymeric materials, such as those mentioned above, by reaction with a chemical compound such as, for example, an organic peroxide.

According to another aspect of the present invention what is also proposed is a process for synthesizing a polymeric material by means of the extruder described above, in which:
a material to be polymerized is introduced into the extruder;
in each introduction device present:
   at least one chemical compound is introduced via a pump into the mixing chamber,
   the carbon dioxide, precooled, is introduced via a pump into the mixing chamber and
   the chemical compound or compounds and the carbon dioxide are mixed in the mixing chamber;
the mixture or mixtures thus obtained are introduced into the extruder; and
the material to be polymerized is extruded together with the mixture or mixtures under conditions allowing a reaction between at least one of the chemical compounds and the material to be polymerized, and the polymeric material thus formed is extruded.

In the process for synthesizing a polymeric material according to the invention, at least one of the chemical compounds is a chemical initiator, that is to say a compound capable of initiating the polymerization of the material to be polymerized.

In the process for synthesizing a polymeric material according to the invention, the injector of each device for introducing the chemical initiator or initiators is preferably placed so as to be perpendicular to the feed zone of the extruder.

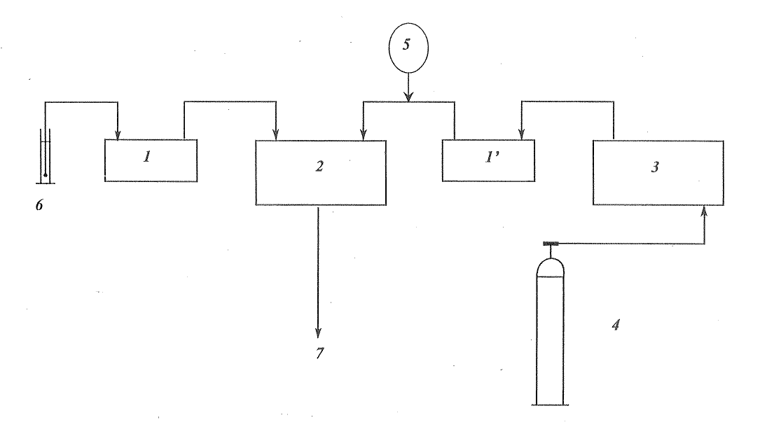

One advantageous embodiment of the introduction device is described in greater detail by way of illustration in FIG. 1.

FIG. 1 shows a container 6 for a chemical compound (there could be several of them within the meaning of the present invention) which is fed into the mixing chamber 2 by means of a pump 1. The carbon dioxide contained in the container 4 is cooled in the cryothermostat 3 before being fed into the mixing chamber 2 by means of a pump 1′. The mixture of the chemical compound or compounds (if there are several containers) and of the carbon dioxide which is produced in the mixing chamber is then discharged into the injector 7, the pressure of which is measured by means of a pressure sensor 5.

The device according to the invention has many advantages. Thus, it allows one or more chemical compounds to be continuously incorporated into a material to be extruded. Moreover, it allows small amounts of this or these chemical compound or compounds to be introduced, with a uniform rate of introduction which may moreover by kept constant, even when the flow rates of chemical compounds are particularly low. The device according to the invention furthermore avoids the use of organic solvents, the disadvantages of which were mentioned above. It also avoids relatively long purging times and extensive and difficult cleaning of the plant. Finally, the device according to the invention has the advantage of a higher degree of flexibility with regard to the amount of the chemical compound or compounds to be introduced and with regard to the point at which the introduction of the chemical compound or compounds can take place.

The example which follows serves to illustrate the present invention without thereby limiting the scope thereof.

### EXAMPLE

This example describes the modification of an ε-caprolactone polymer by the reaction of the latter with a chemical compound which is an organic peroxide.

ε-Caprolactone Polymer

The ε-caprolactone polymer was poly-ε-caprolactone CAPA® 680 sold by Solvay Interox.

It was characterized by a number-average molecular mass of 70 000 g/mol. The molecular mass was measured by gel permeation chromatography using chloroform as solvent, by means of a column of the Polymer Laboratories Mix-C type and a refractometer of the Waters Differential Refractometer R401 type.

The concentration of the specimen was 20 mg/ml and the flow rate was 1 ml/min. The standards used were polystyrene standards and the conversion factor used was 0.6.

The poly-ε-caprolactone was characterized by a melting point of 58-60° C., measured by differential thermal analysis, in the second pass and with a scan rate of 10 K/min.

The poly-ε-caprolactone was also characterized by an MFI of 2.11 dg/min., obtained by measuring the amount of polymer passing through a calibrated cylindrical die (height: 8 mm±0.025 mm; diameter: 2.095 mm±0.003 mm) at a temperature of 100° C. and under a load of 5 kg.

Organic Peroxide

The organic peroxide was 2,5-dimethyl-2-5-di-tert-butylperoxyhexane (DHIBP) sold under the brand name LUPERSOL® 101 by Peroxid Chemie.

Extruder

The extruder used was a Werner & Pfleiderer ZSK® 40 corotating double-screw extruder. The diameter of the screws was 40 mm and their length was 1 360 mm. The rotation speed of the screws was 200 rpm (rotations per minute).

The extruder was designed so that it comprised, in succession, a feed zone, a material melting zone, a homogenization zone, a reaction zone and a discharge zone preceded by a compression zone. Each of these zones was at a very specific temperature.

The feed zone was at a temperature less than or equal to 20° C.

The material melting zone was at a temperature of 130° C., the DHBP was introduced into this mixing zone with the carbon dioxide by means of the introduction device described above.

The homogenization zone was at a temperature of 130° C.

The reaction zone was at a temperature of 180° C.

The compression zone was at a temperature of 180° C.

The discharge zone was at a temperature of 180° C.

Introduction Device

The device for introducing the mixture of the organic peroxide and carbon dioxide is shown schematically in FIG. 1.

The DHBP contained in the container 6 was fed into the mixing chamber 2 by means of the pump 1. The liquid carbon dioxide contained in the container 4 was cooled to −10° C. in the cryothermostat 3 before being fed into the mixing chamber 2 by means of a pump 1′. The mixture of DHBP and liquid carbon dioxide produced in the mixing chamber was then discharged into the injector 7, the pressure of which was measured by means of a pressure sensor 5.

The liquid carbon dioxide container 4 was a pressurized carbon dioxide cylinder.

The pumps 1 and 1′ were pumps of the Gilson 305 or 306 type. The head of the pump 1′ designed for carbon dioxide was fitted with a Gilson 5/10/25SG kit allowing the head to be cooled to −10° C. The coolant was isopropanol cooled in a JUBALO F30-type cryothermostat.

The same cryothermostat was used to cool the liquid carbon dioxide (cryothermostat 3).

The mixing chamber 2 was an analytical mixer provided with a Gilson 811C-type stirrer.

The injector 7 was an injector for working at high pressure (above 74 bar).

A pressure sensor 5 of the Gilson 806 type was placed between the pump 1′ and the mixing chamber 2 so as to measure the pressure (between 90 and 120 bar) in the injector.

The injector of the introduction device was placed so as to be perpendicular to the barrel of the extruder and emerged tangentially with respect to the extrusion screw flights. It was placed specifically so as to perpendicular to the melting zone of the extruder. The carbon dioxide was generally in the supercritical state within the injector.

Modification of the ε-caprolactone Polymer by DHBP

The poly-ε-caprolactone CAPA® 680 was introduced into the feed zone of the extruder described above at a rate of 30 kg/h and propagated along the various zones of the extruder.

In the melting zone of the extruder, the DHBP, as a mixture with carbon dioxide, was sprayed onto the poly-ε-caprolactone by means of the introduction device described above. The DHBP was introduced in an amount of 1 g per kg of poly-ε-caprolactone CAPA® 680 and in an amount of 570 μl of DHBP in 5 ml of carbon dioxide per minute.

The poly-ε-caprolactone obtained was characterized by an MFI of 0.42 dg/min., obtained by measuring the amount of polymer passing through a calibrated cylindrical die (height: 8 mm±0.025 mm; diameter: 2.095 mm±0.003 mm) at a temperature of 100° C. and under a load of 5 kg.

This application is a Continuation application of U.S. application Ser. No. 10/030,144, filed Apr. 30, 2002, now pending; which is a 371 of PCT/EP00/06970, filed Jul. 20, 2000. In addition, priority to Belgium Application 09900511, filed Jul. 27, 1999.

1. A method for modifying a polymeric material, comprising:
introducing the polymeric material into an extruder comprising a feed zone, a compression zone and a discharge zone, and equipped with at least one introduction device comprising a first pump, a second pump, a mixing chamber, a pressure sensor, and an injector,
introducing into each introduction device:
at least one chemical compound in the fluidized state via the first pump into the mixing chamber,
precooled carbon dioxide via the second pump into the mixing chamber,
whereby the chemical compound(s) and the carbon dioxide are mixed in the mixing chamber to provide a mixture,
introducing the mixture(s) into the interior of the extruder, into a zone of the extruder where the polymeric material is in the fluidized state, via the injector, and
extruding the polymeric material together with the mixture(s) under conditions permitting reaction between at least one of the chemical compounds and the polymeric material,
wherein the pressure at the injector, measured by the pressure sensor, is above 74 bar and the temperature is above 31.4° C., and the carbon dioxide is in the supercritical state.

2. The method according to claim 1, wherein the zone of the extruder into which the mixture(s) is/are introduced is a zone where the polymeric material is in the viscous liquid state.

3. The method according to claim 1, wherein the polymeric material is a vinyl polymer.

4. The method according to claim 3, wherein the vinyl polymer is a homopolymer of an olefin, a copolymer of an olefin, a halogenated vinyl homopolymer or a halogenated vinyl copolymer.

5. The method according to claim 3, wherein the vinyl polymer is a homopolymer of vinylidene fluoride or a copolymer of vinylidene fluoride.

6. The method according to claim 1, wherein the polymeric material is a thermoplastic aliphatic polyester.

7. The method according to claim 6, wherein the thermoplastic aliphatic polyester is a polymer of ε-caprolactone.

8. The method according to claim 1, wherein the chemical compound(s) is/are liquid at room temperature.

9. The method according to claim 1, wherein the chemical compound(s) is/are solid at room temperature and the introduction device is adapted in such a way that the chemical compound(s) is/are in the fluidized state.

10. The method according to claim 1, wherein the pressure in the interior of the injector is at least 90 bar.

11. The method according to claim 1, wherein the extruder comprises a barrel, and the injector is arranged perpendicularly to the barrel.

12. The method according to claim 1, wherein the extruder comprises an extrusion screw, and the injector emerges tangentially to the extrusion screw flights.

13. The method according to claim 1, wherein the mixing chamber is equipped with an agitation system.

14. A method for synthesizing a polymeric material, comprising:
introducing a material to be polymerized into an extruder comprising a feed zone, a compression zone and a discharge zone, and equipped with at least one introduction device comprising a first pump, a second pump, a mixing chamber, a pressure sensor, and an injector,
introducing into each introduction device:
at least one chemical compound in the fluidized state via the first pump into the mixing chamber,
precooled carbon dioxide via the second pump into the mixing chamber,
whereby the chemical compound(s) and the carbon dioxide are mixed in the mixing chamber to provide a mixture,
introducing the mixture(s) into the interior of the extruder, into a zone of the extruder where the material to be polymerized is in the fluidized state, via the injector, and
polymerizing the material to be polymerized together with the mixture(s) in conditions permitting reaction between at least one of the chemical compounds and the material to be polymerized, and
extruding the resultant polymeric material,
wherein the pressure at the injector, measured by the pressure sensor, is above 74 bar and the temperature is above 31.4° C., and the carbon dioxide is in the supercritical state.

15. The method according to claim 14, wherein the zone of the extruder into which the mixture(s) is/are introduced is a zone where the material to be polymerized is in the liquid state.

16. The method according to claim 14, wherein the polymeric material is a thermoplastic aliphatic polyester.

17. The method according to claim 16, wherein thermoplastic aliphatic polyester is a polymer of ε-caprolactone.

18. The method according to claim 14, wherein the chemical compound(s) is/are liquid at room temperature.

19. The method according to claim 14, wherein the chemical compound(s) is/are solid at room temperature and the introduction device is adapted in such a way that the chemical compound(s) is/are in the fluidized state.

20. The method according to claim 14, wherein the pressure in the interior of the injector is at least 90 bar.

21. The method according to claim 14, wherein the extruder comprises a barrel, and in that the injector is arranged perpendicularly to the barrel.

22. The method according to claim 14, wherein the extruder comprises an extrusion screw, and the injector emerges tangentially to the extrusion screw flights.

23. The method according to claim 14, wherein the material to be polymerized comprises at least one monomer.

24. The method according to claim 14, wherein the mixing chamber is equipped with an agitation system.
